(19) United States
(12) Patent Application Publication
(10) Pub. No.: US 2009/0084732 A1
(43) Pub. Date: Apr. 2, 2009

(54) Liquid Desiccant Device

(76) Inventor: Kye-Simeon Masters, Antwerp (BE)

Correspondence Address: Kye-Simeon Masters c/o Igor Gonda, Unit 218, 650 Delancey Street, San Francisco, CA, 94107, US

(21) Appl. No.: 11/570,128

(22) PCT Filed: Jun. 23, 2005
(86) PCT No.: PCT/AU2005/000905

§ 371 Date: Oct. 14, 2008

(30) Foreign Application Priority Data
Jun. 28, 2004 (AU) 2004903535

(51) Int. Cl. B01D 15/08; B01D 39/02; B01D 27/02

(52) U.S. Cl. 210/689; 210/502.1; 210/282; 210/232

(57) ABSTRACT

A liquid desiccation device is disclosed. The device removes traces of water from substantially non-aqueous liquids in a simple and expedient manner. It comprises a porous container which allows water in to bind with a desiccant contained within, and contains that desiccant so that it may be removed piecemeal once the drying process is complete.

### FIELD OF THE INVENTION

The present invention relates to a device for the removal of water from substantially non-aqueous liquids and a method of using the device. Typically the present invention relates to removal of water from liquids required for (a) research/development or (b) industrial chemistry-related processes such as petroleum treatment and refinement.

### BACKGROUND OF THE INVENTION

In this specification where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

While the present invention will be described principally with reference to liquid solvents it will be appreciated that the invention is not limited to this application, but can be used to remove water from a wide range of liquids including liquid reactants. Contamination of non-aqueous liquids with water is a common problem in a variety of situations.

In many chemical processes water needs to be removed from liquid solvent or reactant. Water present in a solvent or reactant is an impurity and, like other impurities, may adversely affect the quality of any analysis or reactions involving the solvent or reactant. For example, presence of water may cause unwanted reactions or by-products. Water in petroleum products used as engine fuels can adversely affect engine output to the point of stalling and in extreme cases, permanently damage the engine.

The water can be derived from a wide range of sources. For example, water may be a by-product of synthesis of the liquid. Alternatively, or in addition, water may subsequently become incorporated into the liquid, by absorption from the surrounding environment (i.e. atmosphere), or as a result of a step in a chemical process such as liquid-liquid extraction. Methods typically used for removing water from organic liquids include:
a) drying the solvent by application of a particulate drying agent (magnesium or sodium sulfate, calcium chloride, molecular sieves or other inorganic agent), which is immersed in the liquid and agitated. All traces of the drying agent and adsorbed water are then removal by filtration.
b) passing the liquid through a tube containing a commercially available drying agent. The drying agent is retained in the tube by porous material (such as a glass frit or glass wool) at either end of the tube.
c) distilling the solvent from a reducing agent (such as sodium or potassium metal or a metal hydride), which converts water to an insoluble hydroxide.

For example, desiccant devices of the prior art include that described in International Patent WO 99/12641 (Nesterov) which includes a solid, porous carrier with a hygroscopic material impregnated within, for the purpose of atmospheric dehydration. WO 01/08784 A1 (Beckenhauer) describes several desiccant materials designed to remove water from the atmosphere, the desiccant material being produced by admixing components comprising a hygroscopic material and an organic polymer.

Petroleum products are an example of organic liquids that are frequently ‘wet’, that is, contaminated with water. Once again, the water may be present due to a variety of reasons. For example water may naturally be present in the underground reserve from which the petroleum product is pumped, or it may be included into the petroleum product as a result of exposure during transportation and other processes. There are a variety of processes for the removal of water from petroleum that are usually performed at the refinement stage of its production and distribution. Frequently there is also a need for more localized secondary dehydration, often on a smaller scale. For example, fine droplets of water dispersed in petroleum may coalesce and ‘drop out’ when it cools to a lower temperature, at higher altitudes or in cooler climes.

One of the problems of the devices and methods of the prior art are that they require significant time and resources.

There is therefore a need for a device and method to substantially reduce the amount of time and resources used in order to perform dehydration of liquids in comparison with traditional methods.

### SUMMARY OF THE INVENTION

The present invention provides a device for removal of water from a substantially non-aqueous liquid, the device including:
a desiccant, and
a porous container suitable for immersion in the substantially non-aqueous liquid,
   wherein upon immersion of the device water is retained in association with the desiccant, and is separated from the non-aqueous liquid upon removal of the device from the non-aqueous liquid.

The device thus permits removal of most of the water in a single immersion and removal step.

The desiccant may be any of the many compounds well known to those skilled in the art for adsorbing water from liquids including dehydrated salts or hydrophilic solids of other kinds. Preferably the desiccant is chosen from the group comprising alkaline earth or alkali metal compounds, such as sulfates, carbonates, halides or mixtures thereof. It is particularly preferred that the desiccant include metal sulfates or metal halides such as magnesium sulfate, sodium sulfate or calcium chloride. The desiccant may be in any convenient form, but in order to maximise surface area of the desiccant, and thus increase contact with water, the desiccant may be granulated or powdered to a variety of particle sizes. For example, 3 grams of MgSO₄.3H₂O can absorb up to 1 mL of H₂O to form the saturated species MgSO₄.7H₂O.

Typically the container is a vessel that encloses and retains the desiccant. In this embodiment the container is sufficiently porous to allow free movement of liquid to the inside, where it can contact the desiccant and become bound or adsorbed to it. For example the container may be comprised of fabric, such as woven natural or synthetic fibre or paper.

In another embodiment, the container may be a cohesive solid hydrophilic material that consists of, or incorporates the desiccant within its structure. This may be in the form of a solid molded salt such as that described above, eg MgSO₄.3H₂O.

The container may be any convenient size appropriate to the purpose to which it is applied. One of the advantages of the present invention is that it can be applied to removal of water from large or small volumes of liquid. For example, the invention could be used for bench scale removal of water, such as would be required in a research laboratory. This would for example, replace the use of filter paper and fuinel to remove particulate desiccant from a liquid. Furthermore dehydrations could be performed in flasks where subsequent evaporation will take place, reducing further the total amount of equipment necessary to use, and then clean, for such a procedure.

The container may include an integral or removable attachment for facilitating location of the container in the non-aqueous liquid, or removal of the container from the non-aqueous liquid. Typically the attachment comprises an elongate member such as a string of natural or synthetic material.

Liquids referred to herein can include pure organic or inorganic liquids or mixtures thereof. Typically, when the liquid is organic, it is chosen from the group comprising hydrocarbons such as hexane, halogenated carbon compounds such as dichloromethane and carbon tetrachloride, ethers, esters, acids, aldehydes or any other liquid which is not infinitely miscible with water (for example methanol and water) and mixtures thereof. Typically when the liquid is inorganic, it is chosen from the group comprising inorganic acids and mixtures thereof.

Water may be incorporated or associated with the desiccant by any physical or chemical means known in the art. For example the water may be adsorbed onto the surface of the desiccant, may react with the desiccant or may be trapped within the desiccant (such as when the desiccant is in the form of molecular sieves). When the water is removed with the desiccant from the liquid, the water may be present in the sate of an emulsion, solution or discrete ‘droplets’. The container of desiccant may be rinsed down with further solvent in cases where the liquid originally contained a valuable solute.

There is further provided a method for removing water from a substantially non-aqueous liquid using the device of the present invention, the method comprising the steps of:
(a) locating the device in the liquid for a period of time, water being retained in association with the desiccant, and
(b) removing the device from the liquid such that the water is separated upon removal of the device from the non-aqueous liquid.

The method of the present invention will typically remove at least 99% by volume of water present in a liquid, more typically at least 99.9% by volume of water present.

### EXAMPLES

The present invention will be further described with reference to the following non-limiting examples.

### Example 1

A 5×5 cm square, two-faced container of cellulose paper filled with a desiccant comprised of MgSO₄.3H₂O (3 grams) was immersed in 100 mL of chloroform containing 1% H₂O. The liquid came into contact with the desiccant by gradual dissipation of the liquid through the walls of the container over ten minutes, or over two minutes with thorough agitation. The water became trapped in association with desiccant. Once the liquid had become suitably dry and clear in appearance the desiccant was removed with the device from the liquid. By this method the water (1 mL) and desiccant is removed piecemeal with the container, and the need for a secondary process to remove it (eg. filtration) is circumvented. The device indicated that it had become saturated with water through a change of the previously powdery drying agent contained to a hard, brittle mass.

### Example 2

The above procedure was repeated using a 7×7 cm square cellulose paper container enclosing 10 grams of magnesium sulfate. The container was placed in 500 mL of ethyl acetate and agitated for 1 minute then removed. The water content of the ethyl acetate was thus reduced from 3 mL (0.6%) to 0.01 mL (0.002%).

### Comparative Example 2

500 mL of ethyl acetate containing 13 grams of hydrated magnesium sulfate was filtered through a fluted 15 cm Grade 1 Whatman filter paper. By pouring small amounts of the liquid through the filter paper, filtration took in excess of 5 minutes to complete. The water content of the ethyl acetate was thus reduced from 3 mL (0.6%) to 0.01 mL (0.002%).

Thus the method of Example 2 constitutes a substantial time saving, particularly when removal of water must be repeated multiple times during a day.

### Example 3

A conical flasks containing 250 mL ethyl acetate was contaminated with one mL of distilled water. The flask (Flask A) was then dehydrated as follows: A thin cellulose container with 4 grams of MgSO₄.3H₂O according to the present invention was dropped into the flask and it was agitated thoroughly (light shaking and vigorous swirling) for one minute. The device was then removed from flask A and contents poured into a round-bottomed quickfit flask.

### Comparative Example 3a

A second conical flasks containing 250 mL ethyl acetate was contaminated with one mL of distilled water. The flask (Flask B) then was dehydrated in a ‘traditional’ manner; 4 grams of MgSO₄.3H₂O was then dropped into the flask and it was agitated thoroughly for one minute. The ethyl acetate was then slowly filtered through Whatman filter paper and poured into a round-bottomed quickfit flask.

Flask A (Example 3) and Flask B (Example 3a) were each evacuated of solvent on the rotary evaporator until such time as only ˜100 μL of liquid remained. This was then dissolved in CDCl₃ and a proton NMR generated on a 300 MHz Bruker machine. The NMR spectra (see FIGS. 3 and 4 below) show clearly near-identical positive results between the two methods in their ability to remove water from the substantially non-aqueous liquid, as evidenced by the lack of a significant water peak at δ=1.56 ppm (there is some water present which is attributable to the deuterated chloroform).

### DRAWINGS & FIGURES

Various embodiments/aspects of the invention will now be described with reference to the following non-limiting examples.

FIG. 1 is a drawing of one possible form of the invention showing a porous container similar to a tea-bag holding a drying agent or desiccant.

FIG. 2 is a drawing of the invention immersed in a container of wet organic solvent held within a round bottomed flask.

FIGS. 3 and 4 are proton nuclear magnetic resonance spectra.

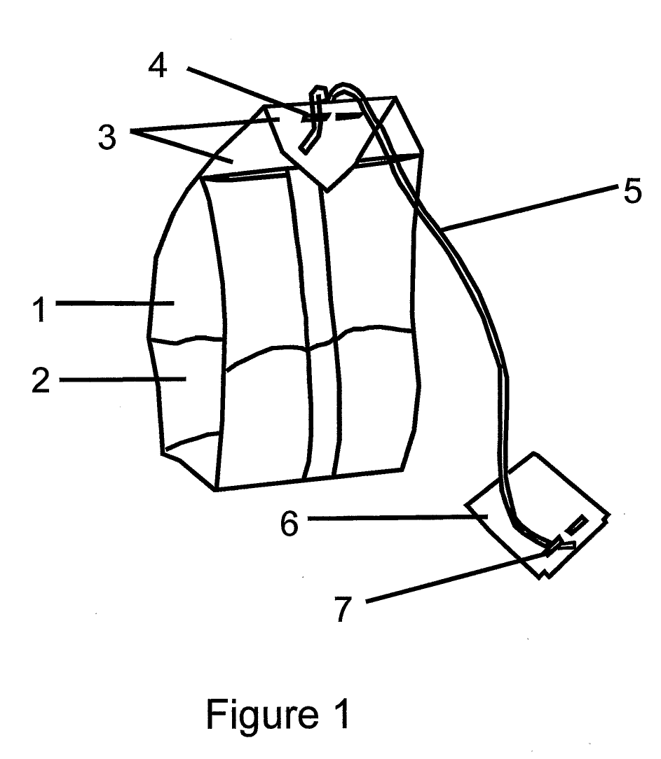

With reference to FIG. 1 it can be seen that the liquid desiccant bag described herein comprises a porous container or bag 1 containing a measure of powdered or granulated drying agent 2. The container is fastened (eg. folded) in such a way 3 as to occlude the drying agent from spilling into the liquid to be dried. A staple or fastening attaches a string 5 to the bag to which a tab 6 is attached by a staple 7 so that the invention can be removed from the solvent comfortably.

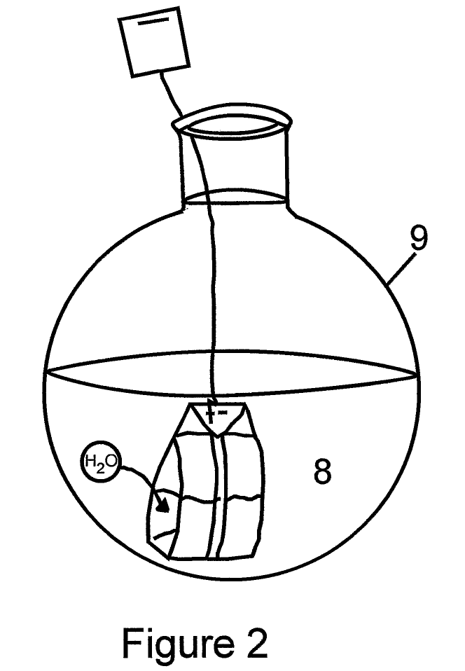

Referring to FIG. 2, the device is immersed in a liquid 8, to be dried within a receptacle 9. Water is shown pictorially as entering the device from the surrounding liquid.

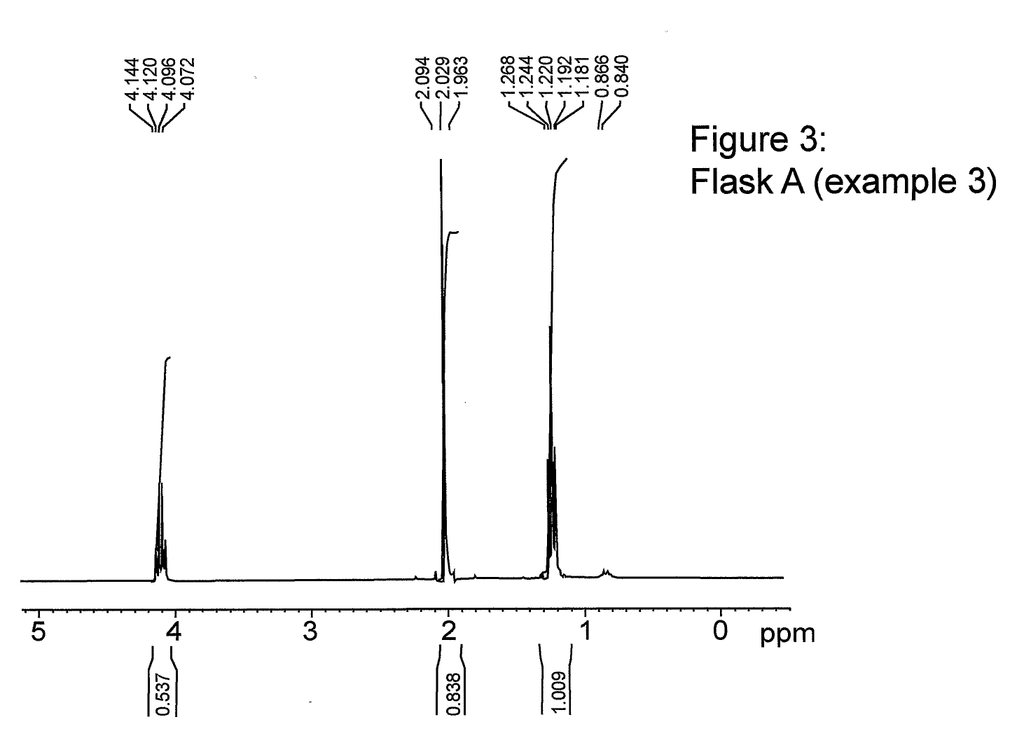

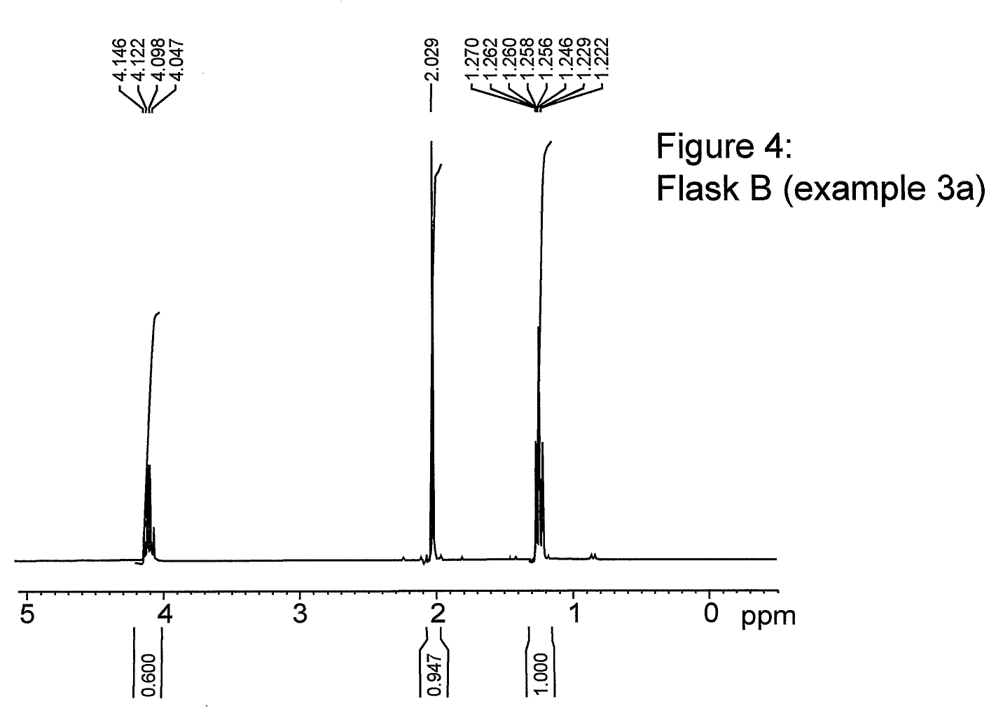

FIGS. 3 and 4 are proton NMR spectra showing the results of the experimental dehydration procedure described above at Example 3. FIG. 3 demonstrates the experimental efficacy of the invention as compared with a control (as demonstrated in FIG. 4).

The word comprising and forms of the word comprising as used in this description does not limit the invention claimed to exclude any variants or additions.

Modifications and improvements to the invention will be readily apparent to those skilled in the art. Such modifications and improvements are intended to be within the scope of this invention.

1. A device for removal of water from a substantially non-aqueous liquid, the device including:
(a) a desiccant, and
(b) a porous container suitable for immersion in the substantially non-aqueous liquid,
wherein upon immersion of the device water is retained in association with the desiccant, and is separated from the non-aqueous liquid upon removal of the device from the non-aqueous liquid, and wherein the dessicant is chosen from the group comprising alkaline earth or alkali metal compounds or mixtures thereof.

2. A device according to claim 1 wherein the dessicant is chosen from the group comprising metal sulfates, metal halides or mixtures thereof.

3. A device according to claim 1 wherein the desiccant is in particulate form.

4. A device according to any one of the preceding claims wherein the container is comprised of porous material and encloses the dessicant.

5. A device according to claim 4 wherein the container is comprised of materials chosen from the group comprising fabric or paper.

6. A device according to any one of claims 1 to 4 wherein the dessicant is incorporated into the porous container.

7. A device according to claim 6 wherein the porous container is at least partially comprised of molded salt.

8. A device according to claim 7 wherein the molded salt is the dessicant.

9. A device according to any one of claims 4 to 8 wherein the container further includes an attachment for facilitating location or removal of the container from the substantially non-aqueous liquid.

10. A method of removing water from a substantially non-aqueous liquid using the device according to any one of claims 1 to 9, the method comprising the steps of:
(a) locating the device in the liquid for a period of time, water being retained in association with the desiccant, and
(b) removing the device from the liquid such that the water is separated upon removal of the device from the liquid.

11. A method of removing water according to claim 10 wherein the removal of water is greater than 99% by volume.

12. A method of removing water according to claim 10 wherein the removal of water is greater than 99.9% by volume.

13. A method of removing water according to claim 10 wherein the substantially non-aqueous liquid is chosen from the group comprising hydrocarbons, halogenated carbon compounds, ethers, esters, acids, aldehydes or any other liquid which is not infinitely miscible with water and mixtures thereof.

14. A device according to claim 1 and substantially as herein described with reference to the drawings.

15. A device according to claim 1 and substantially as herein described with reference to the examples.

16. A method according to claim 10 and substantially as herein described with reference to the examples.
